(19) United States
(12) Patent Application Publication
(10) Pub. No.: US 2006/0129589 A1
(43) Pub. Date: Jun. 15, 2006

(54) System and method of securing computer-readable media

(75) Inventors: Anthony D. Thornton, Hilliard, OH (US); Robert H. Houghton, Hilliard, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(73) Assignees: Micro Electronics, Inc., Hilliard, OH (US); THORNTON, Anthony D.

(21) Appl. No.: 11/009,202

(22) Filed: Dec. 10, 2004

(51) Int. Cl. G06F 7/00

(52) U.S. Cl. 707/102

(57) ABSTRACT

Systems, methodologies, media, and other embodiments associated with securing a computer-readable medium are described. One exemplary system embodiment includes receiving a user supplied command to secure a computer-readable medium having at least one data structure including data and a directory identifying data locations within the data structure, and securing the directory in place.

### BACKGROUND

Many businesses employ computer assets that generate and store electronic data including sensitive customer information. In some cases, this information is subject to privacy laws, regulations, business practices and the like making confidentiality desirable. Businesses may use various on-site data security procedures prior to sending systems and hard drives offsite for asset management services, such as recycling, refurbishing, reselling and the like. In some situations, businesses remove and physically destroy hard drives entirely to ensure sensitive data is not disclosed.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example computing environment in which example systems and methods illustrated herein can operate.

FIG. 2 illustrates an example methodology associated with securing computer-readable media.

FIG. 3 is a representation of a computer-readable medium.

FIG. 4 illustrates another example methodology associated with securing computer-readable media.

FIG. 5 is another representation of a computer-readable medium.

FIG. 6 illustrates an embodiment of a software product suitable to secure a computer-readable medium.

FIG. 7 illustrates another example methodology associated securing computer-readable media.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Address”, as used herein, includes but is not limited to one or more communication network accessible addresses, device identifiers, IP addresses, e-mail addresses, a distribution list including one or more e-mail addresses, url and ftp locations or the like, network drive locations, a postal address, or other types of addresses that can identify a desired destination or device.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer communication”, as used herein, refers to a communication between two or more computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate signals, instructions, data, or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device like a field programmable gate array (FPGA), a memory device containing instructions, combinations of logic devices, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

“Internet”, as used herein, includes a wide area data communications network, typically accessible by any user having appropriate software.

“Intranet”, as used herein, includes a data communications network similar to an internet but typically having access restricted to a specific group of individuals, organizations, or computers.

“Network”, as used herein, includes but is not limited to the internet, intranets, Wide Area Networks (WANs), Local Area Networks (LANs), and transducer links such as those using Modulator-Demodulators (modems).

Network Communication Protocol Examples: Communication between a client computer and a server may take place using one of several network protocols, such as hypertext transfer protocol (HTTP), file transfer protocol (FTP), Common Internet File System (CIFS) protocol, Gopher, other available protocol, or a custom protocol. For purposes of simplicity, the following example will be primarily described with respect to HTTP.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

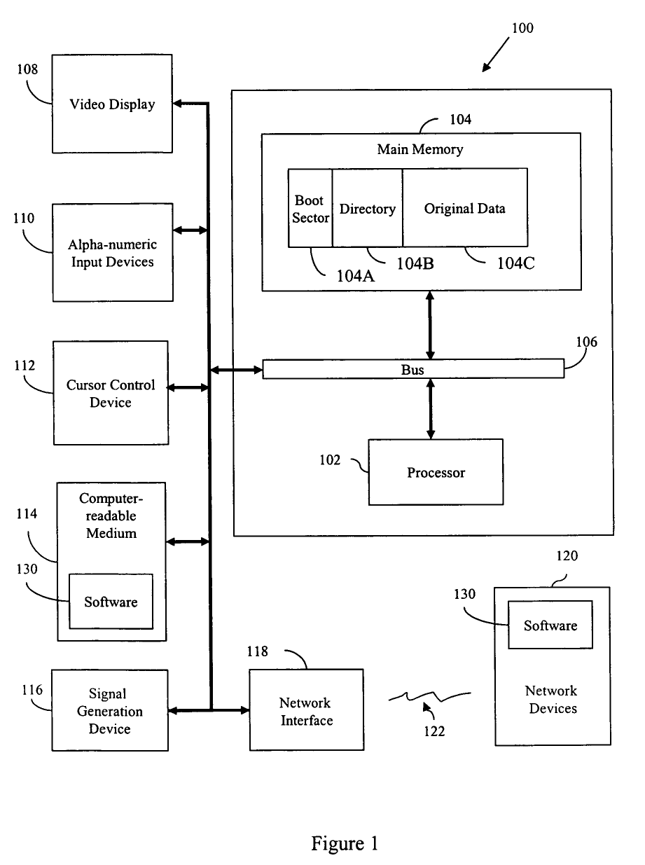

FIG. 1 illustrates an example computing device 100 in which example systems and methods described herein, and equivalents, can operate. The computing device 100 includes a processor 102 in computer communication with a computer-readable medium shown as main memory 104, via a bus 106. The main memory may be configured as a hard-drive or other computer-readable medium and may include a data structure configured as a logical partition. In a Microsoft-type system, the data structure may include a boot sector 104A, a directory 104B such as a File Allocation Table (FAT) or New Technology File System (NTFS), and data 104C. It is to be appreciated that other systems, for example Unix or Apple, also employ file systems where generalized directories refer to data locations. As such, in other embodiments, different systems may be accommodated.

The computing device 100 is further shown to include a video display unit 108, for example, a liquid crystal display (LCD), a cathode ray tube (CRT), and the like. The computing device 100 also includes an alpha-numeric input device 110, for example, a keyboard; a cursor control device 112, for example, a mouse or trackball and the like; a secondary computer-readable medium 114, for example a disk drive unit, memory stick and the like; a signal generation device 116, for example, a speaker; and a network interface 118 which may permit the computing device 100 to be in computer communication with other computer components such as network devices 120 over a network 122. Computer-readable medium 114 may include software 130 to be completely or partially, loaded into the main memory 104 and/or within the processor 102. In one embodiment, the software 130 may be transmitted or received via the network interface device 118.

The computer-readable medium 114 may be configured as disk operably connected to the processor 102. The disk can include, but is not limited to, devices like a magnetic disk drive, a solid state disk drive, a floppy disk drive, a tape drive, a Zip drive, a flash memory card, and/or a memory stick. Furthermore, the disk can include optical drives like a CD-ROM, a CD recordable drive (CD-R drive), a CD rewriteable drive (CD-RW drive), and/or a digital video ROM drive (DVD ROM). The main memory 104 can store processes and/or data, for example. The disk and/or memory 104 can store an operating system that controls and allocates resources of the computing device 100.

The bus 106 can be a single internal bus interconnect architecture and/or other bus or mesh architectures. While a single bus is illustrated, it is to be appreciated that computing device 100 may communicate with various devices, logics, and peripherals using other busses that are not illustrated (e.g., PCIE, SATA, Infiniband, 1394, USB, Ethernet). The bus 106 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computing device 100 can operate in a network environment and thus may be connected to network devices 120 via the I/O devices 118. Through the network devices 120, the computing device 100 may interact with a network. Through the network, the computing device 100 may be logically connected to remote computer components. Exemplary networks 122 with which the computing device 100 may interact include, but are not limited to, a local area network (LAN), a wide area network (WAN), and other networks. The network devices 120 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, the network devices 120 can connect to WAN technologies including, but not limited to, the internet, intranets, point to point links, circuit switching networks like integrated services digital networks (ISDN), packet switching networks, and digital subscriber lines (DSL).

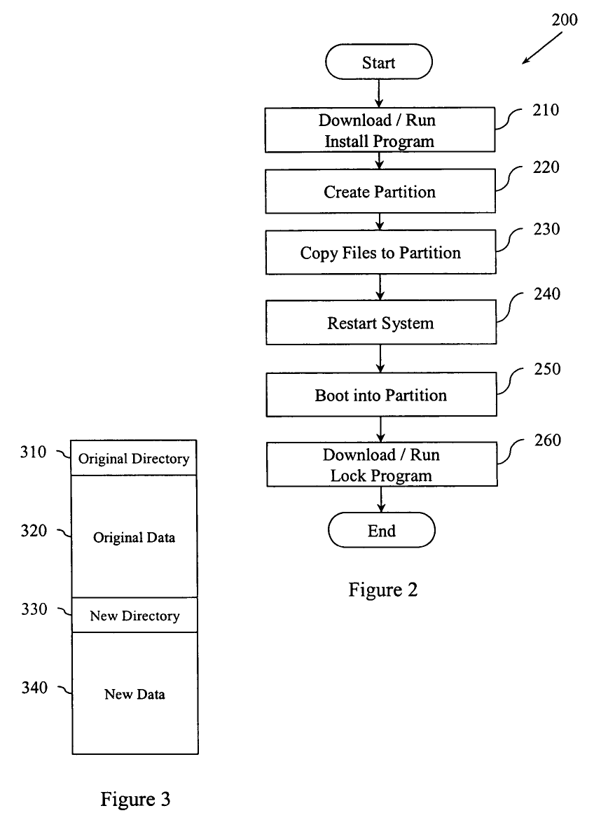

Example methods may be better appreciated with reference to the flow diagrams of FIGS. 2 and 3. While for purposes of simplicity of explanation, the illustrated methodologies are shown and described as a series of blocks, it is to be appreciated that the methodologies are not limited by the order of the blocks, as some blocks can occur in different orders and/or occur concurrently with other blocks from that shown and described. Moreover, less than all the illustrated blocks may be required to implement an example methodology. Furthermore, additional and/or alternative methodologies can employ additional, not illustrated blocks.

In the flow diagrams, blocks denote “processing blocks” that may be implemented with logic. In the case where the logic may be software, a flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software logic may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques. The foregoing applies to all methodologies herein.

Illustrated in FIG. 2 is an example methodology 200 associated with securing a computer-readable medium or other forms of computer components having persistent memory. A computer system may invoke the software (FIG. 1, block 130) either locally or over a network, for local execution, block 210. An install program checks for sufficient slack space and availability on the target computer-readable medium (FIG. 1, block 104) and creates a partition on the target computer-readable medium, block 220.

In one WinIntel-type embodiment, the partition can be created with the following steps.

(1) Determine the number of partitions available in the disk, for example primary partition count and logical partition count.

(2) If the primary partition count is four then exit the installer application and report an error.

(3) Make a linked list, which will have partition information present in a HDD, for instance like (a) Partition type whether Primary or Logical, (b) File-System type, (c) starting sector of partition, (d) ending sector of partition, (e) copy of BPB (Bios Parameter Block at later point we can use this for reading FAT), and (f) partition number.

(4) Identify the file-system present in the partition.

(5) If it is a FAT implement a algorithm to READ FAT and determine the last free cluster.

(6) If it is NTFS implement a READ BITMAP structure of partition to determine the last free cluster.

(7) Check whether 10,240 continuous free sectors exist.

(8) If 10,240 continuous free sectors exist, proceed.

(9) Shrink the partition.

(10) Add partition table entry for new partition information in the master boot record (MBR).

(11) Create partition and format the partition.

(12) Ensure the partition is updated to the system. Typically this is accomplished by a restart of the system to provide the drive letter to the partition.

With continued reference to FIG. 2, after the partition is created, desired files may be copied, block 230. The files may be computer communicated either from a remote location such as over the internet, or from local media such as from a disk in a local drive. Once the newly created partition and files are copied, the system may be restarted, block 240, and booted from the new partition, block 250. The executable file in the new partition may run the lock software, block 260, more completely discussed below. It should be appreciated that since the system may modify partition table information dynamically, some BIOS based virus scanners might raise alerts for possible virus like activity and may prevent the system from modifying the data structure.

FIG. 3 is a graphic representation of a simple file organizational scheme for an exemplary computer-readable medium. A computer-readable medium may be constructed of data structures configured as logical partitions of a magnetic media. A data structure includes a directory such as a FAT or NTFS and data space having locations referred to by the directory. Prior to creation of the new partition (FIG. 2, block 230), an original partition including original directory 310 and original data space 320 may be present. After creation, original partition 310, 320 remains, and a new partition including new directory 330 and new data space 340 may be present and the new partition 330, 340 may be designated as active, or, in other words, the partition designated to boot the system.

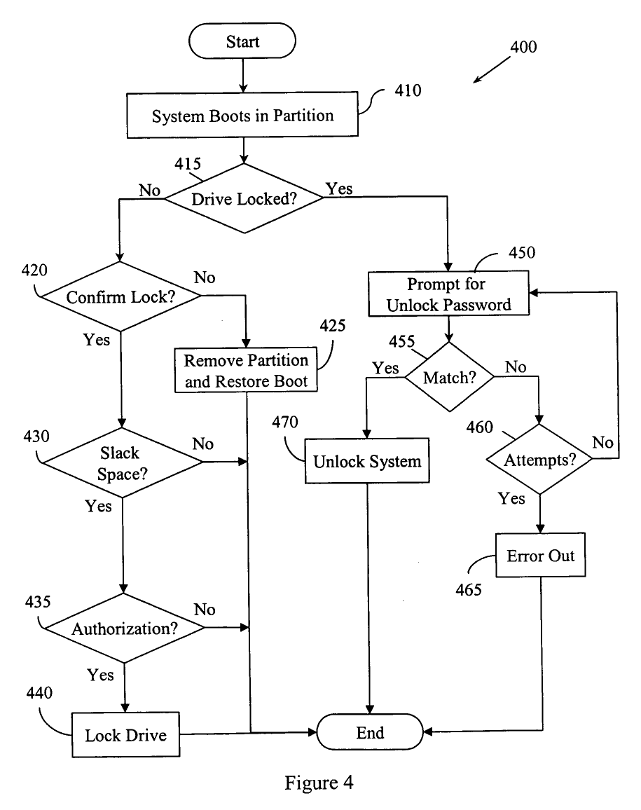

Referring now to FIG. 4, a methodology is illustrated to lock or secure the computer-readable medium. Once the lock software runs from the new partition, block 410, a determination may be made whether the computer-readable medium has been previously secured or locked, block 415. If the computer-readable medium is not locked, a user may optionally be prompted to confirm that locking the computer-readable medium is intended, block 420. If the user fails to confirm intent to lock, the partition may be removed and the previous boot sequence restored, block 425. If the user confirms the intent to lock, sufficient slack space on the computer-readable medium may be verified, block 430, and authorization made, block 435. Authorization can include prompting for passwords to unlock, or to create a computer-readable medium no longer accessible to the user. Authorizing can include verifying proper software licenses have been obtained, accepting certain conditions, such as click-wrap agreements, and vetting through various security measures to identify the user such as password protection, pre-encoded smart card, or by reading biometric data such as a fingerprint, voice pattern or retina scan. Successful authorization may result in locking or securing the computer-readable medium, block 440.

In one embodiment, locking can be accomplished by performing a zero-sum encryption algorithm on the data files identifying file or data locations on the computer-readable medium FAT or NTFS tables in the original bootable partition. Such an encryption algorithm encrypts the target data and remains the same size as the target data and is referred to here as being “in place.” An exemplary zero-sum encryption algorithm is known to those skilled in the art as a poly-alphabetic encryption method, or a poly-alphabetic, single character substitution method. The algorithm may include a back door to allow decryption.

Indeed, successful locking or securing entails encrypting the file tables in each partition contained on the computer-readable medium except the newly created partition. Following success or failure, the system may notify the user of the result.

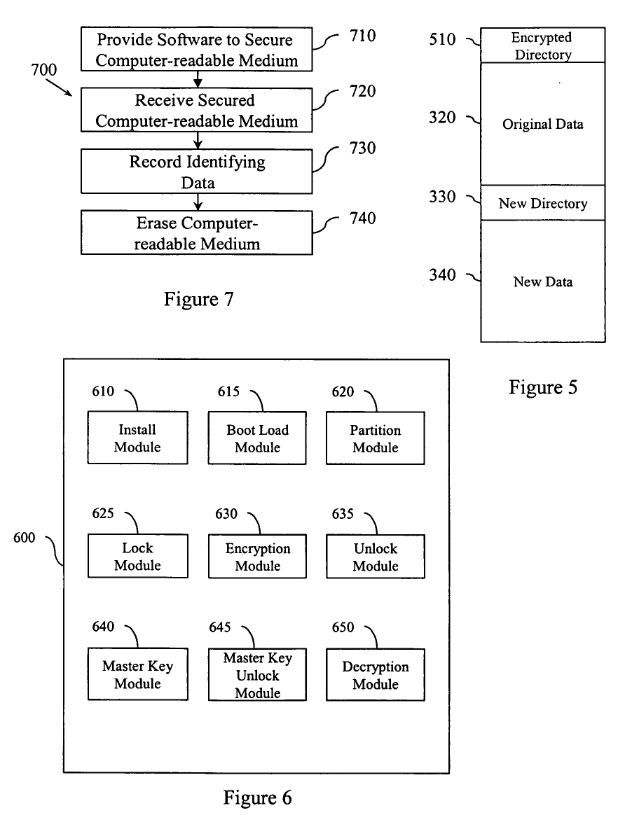

FIG. 5 is a graphic representation of the organizational scheme shown in FIG. 3 following securing. The system may boot into new partition 330, 340 (boot sector and other elements not shown for clarity). Upon locking (FIG. 4, block 440), the original directory 310 may be encrypted in place producing encrypted directory 510 and may leave original data space 320 unaffected, or alternately, the system may encrypt that portion for additional security.

With continued reference to FIG. 4, if a determination is made that the computer-readable medium has been previously secured or locked, block 415, and the system permits user unlocking, the user may be prompted for an unlock password, block 450. Should a supplied password not match, block 455, and a determined number of unsuccessful attempts have not been made, block 460, a user may be presented with additional opportunities to supply the correct password, block 450. Should the correct password not be supplied within a number of times, the system may proceed to a condition prohibiting further unlock attempts, block 465. Should the password be correct, the computer-readable medium may be unlocked, block 470. In the event a password is lost or forgotten, the software may create a file that will enable technicians to successfully unlock the system. It may be desirable to limit such master unlock files to a particular system or user and have the ability only to unlock that system. Upon successful unlock, the system may boot to the original data structure and operating system contained therein. In this embodiment the unlock application may not only unlock the original data structure, but additionally restore the original operating environment as being active and bootable.

FIG. 6, illustrates a software configuration 600 including an installer 610, a boot loader 615, a partition creator 620, a lock module 625, an encryption module 630, an unlock module 635, a master key utility 640, a master key unlock utility 645 and a decryption module 650. The installer 610 may be a windows based program that can install the software on the system to be locked. The boot loader 615 may be installed after the master boot record and may cause the system to boot into the new partition. The partition creation module 620 may scan the primary computer-readable medium to ensure necessary slack space and to create a new partition after resizing the existing partition(s) as needed or desired. The lock module 625 may include the lock tool to initiate the steps to lock the drives on the system. The encryption module 630 may encrypt the FAT, NTFS or other directory structures of the partitions of any and all desired computer-readable media. The unlock module 635 may be used to unlock the computer-readable media previously secured by the lock module 625. The master key utility 640 may be used to generate a master key file if a user cannot unlock the system. The master key unlock utility 645 may use the master key file to unlock the system. The decryption module 650 may decrypt the FAT, NTFS or other directory structures of the partitions encrypted.

FIG. 7, illustrates a method of securing a computer-readable media including providing software to a computer system where securing a computer-readable medium is desired, block 710. Following securing the computer-readable medium, receiving the secured computer-readable medium at a processing facility, block 720. Such a facility can include an IT department within an organization, a recycling or donation facility and the like. The computer-readable medium may be transported by truck, train or any convenient means. The facility may record identifying information, block 730, and erase, over-write, or otherwise render any data on the computer-readable medium unusable, block 740. Optionally, the facility may provide a certificate of destruction or other record-keeping mechanism.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A method of securing a computer-readable medium having at least one data structure, the method comprising:
confirming availability of sufficient space on the computer-readable medium to accommodate a second data structure;
selectively creating the second data structure;
receiving a command to secure the computer-readable medium having at least one data structure including data and a directory identifying data locations within the data structure; and
securing the directory in place.

2. The method as set forth in claim 1, where the securing comprises encoding the directory with a zero-sum encryption algorithm.

3. The method as set forth in claim 2, where the encoding comprises generating a de-encryption key.

4. The method as set forth in claim 1, where the receiving comprises receiving the command from a user, the method further comprising informing the user of success of the securing step.

5. The method as set forth in claim 1, where the securing comprises overwriting the directory rendering the data unreadable.

6. The method as set forth in claim 1, further comprising:
receiving computer executable instructions over a network from a source device, the computer executable instructions configured to create the second data structure and copy an application configured to secure the computer-readable medium into the second data structure.

7. The method as set forth in claim 1, further comprising:
copying computer executable instructions from a second computer-readable medium into the second data structure, the computer executable instructions configured to secure the directory in place.

8. The method as set forth in claim 1, further comprising subsequent to the securing the directory in place:
displaying information regarding the secured status;
receiving a user supplied command to unsecure the directory;
verifying authenticity of the received command; and
unsecuring the directory.

9. A method of securing data stored on a computer-readable medium associated with a computer, the computer-readable medium having at least one data structure, the method comprising:
Checking the computer-readable medium to determine whether a second data structure may be created on the computer-readable medium;
selectively creating the second data structure in the computer-readable medium; and
providing software to the second data structure, the software configured to:
execute upon booting the computer,
query a user regarding securing the data, and
secure the data in response to the query.

10. The method as set forth in claim 9, further comprising after the software has secured the data:
receiving at least the computer-readable medium at a remote facility; and
erasing at least data from the computer-readable medium.

11. The method as set forth in claim 10, further comprising certifying erasure of the computer-readable medium.

12. The method as set forth in claim 9, further comprising prior to the providing software, establishing computer communication between the computer and a remote device configured to provide the software.

13. An article of manufacture comprising:
first software configured to:
confirm availability of sufficient space on a computer-readable medium for a data structure,
create the data structure, and
copy second software into the data structure;
the second software configured to:
accept an instruction to inhibit access to data stored on the computer-readable medium, and
inhibit access to the data by scrambling in place references to the data.

14. The article of manufacture as set forth in claim 13, where the second software is further configured to generate a descrambling key capable of later permitting access to the data.

15. The article of manufacture as set forth in claim 13, where the second software is configured to scramble data by encoding references to the data with a zero-sum encryption algorithm.

16. The article of manufacture as set forth in claim 13, where the second software is further configured to:
accept an instruction to permit access to the data,
verify authenticity of the instruction to permit access to the data, and
permit access to the data by unscrambling in place references to the data.

17. The article of manufacture as set forth in claim 13, further comprising third software configured to remove the data structure containing the second software.

18. A computer having a computer-readable medium configured by the method of claim 9.
